(19) United States
(12) Patent Application Publication
(10) Pub. No.: US 2017/0206816 A1
(43) Pub. Date: Jul. 20, 2017

(54) PROJECTION SYSTEM, PROJECTOR, AND PROJECTION POSITION DETECTION METHOD

(71) Applicant: Seiko Epson Corporation, Tokyo (JP)

(72) Inventor: Shiki Furui, Matsumoto-shi (JP)

(21) Appl. No.: 15/397,876

(22) Filed: Jan. 4, 2017

(30) Foreign Application Priority Data
Jan. 20, 2016 (JP) 2016-008575

(51) Int. Cl. G09G 3/00; H04N 5/225

(52) U.S. Cl. CPC G09G 3/001; H04N 5/225; G09G 2300/026; G09G 2340/14; G09G 2356/00

(57) ABSTRACT

A plurality of projectors is classified into a plurality of projector groups each formed of N projectors, the number N is an integer no smaller than 1 determined for each of the projector groups, and the control device makes the N projectors belonging to the projector group project N arrangement detecting images different from each other at a timing different between the projector groups, makes the projector which does not project the arrangement detecting image perform imaging by the imaging section, and detects an arrangement state of the images projected by the plurality of projectors based on the imaging result.

The entire disclosure of Japanese Patent Application No. 2016-008575, filed Jan. 20, 2016 is expressly incorporated by reference herein.

### BACKGROUND

1. Technical Field

The present invention relates to a projection system, a projector, and a projection position detection method.

2. Related Art

In JP-A-2015-167341 (Document 1), there is disclosed a method of automatically detecting arrangement relationships between projectors in the multiple projection using the plurality of projectors. The projectors are connected to each other with a communication cable, and position discriminating patterns different from each other are projected from the respective projectors at the same time. Further, the own projection range and the periphery of the own projection range are shot the a camera incorporated in each of the projectors to identity the relative positional relationship between the projectors, and the overall arrangement relationship is obtained by integrating the information thereof.

In the system of Document 1, since the plurality of projectors projects the patterns different from each other at the same time, if the number of projectors increases, the number of patterns to be used increases. Conversely, there is a problem that the number of the projectors is limited to the maximum number of the patterns, which can be prepared for the projectors.

### SUMMARY

An advantage of some aspects of the invention is to solve the problem described above, and the invention can be implemented as the following aspects.

(1) According to an aspect of the invention, a projection system is provided. The projection system includes a plurality of projectors adapted to project respective images arranged on a projection surface, and a control device, each of the projectors is provided with an imaging section capable of imaging at least a part of a projection range of another of the projectors when the another of the projectors performs projection at a position adjacent to a projection range of an own projector. The projectors are classified into a plurality of projector groups each formed of N projectors, and the number N is an integer no smaller than 1 determined for each of the projector groups. The control device makes the N projectors belonging to the projector group project N arrangement detecting images different from each other at a timing different between the projector groups, and makes the projector which does not project the arrangement detecting image perform imaging by the imaging section to detect an arrangement state of images, which are projected by the plurality of projectors, based on the imaging result.

According to this aspect of the invention, the arrangement state of the images projected by the plurality of projectors can be detected with smaller number of arrangement detecting images compared to the related art technology. Further, related to a larger number of projectors than in the related part technology, it is possible to detect the arrangement state of the images projected by the projectors.

(2) In the aspect of the invention described above, the number N may be 1 in all of the projector groups.

According to this aspect of the invention, it is sufficient to prepare one arrangement detecting image alone.

(3) In the aspect of the invention described above, the number N may be no smaller than 2 in at least one of the projector groups, and in a case of making the N projectors belonging to the projector group in which the number N is no smaller than 2 project the N arrangement detecting images different from each other, the control device may make the projector which projects the arrangement detecting image perform imaging by the imaging section in addition to the projector which does not project the arrangement detecting image.

In this case, it is possible to detect the arrangement state of the images projected by the plurality of projectors based on the imaging result of each of the projectors even in the case in which the projector group including two or more projectors projects the N arrangement detecting images different from each other.

(4) In the aspect of the invention described above, each of the projectors may be provided with a relative position detection section adapted to detect a relative positional relationship of the arrangement detecting image relative to an own projection position based on the imaging result of the imaging section, and the control device may detect the arrangement state based on the relative positional relationship detected by the relative position detection section.

(5) In the aspect of the invention described above, the control device may make the projector project an own position detecting image at a timing different between the projectors, and make the imaging section perform imaging before projecting the arrangement detecting image, and the relative position detection section may be arranged to detect the own projection position based on the imaging result.

(6) In the aspect of the invention described above, the control device may be a control section provided to one of the plurality of projectors.

According to this aspect of the invention, the control device separate from the projector is unnecessary.

(7) In the aspect of the invention described above, the control device may make the projectors sequentially project an own position detecting image at timings different between the projectors, then make the imaging section perform imaging before projecting the arrangement detecting image, and then recognize a projection position of the projector in an imaging range of the imaging section of each of the projectors based on the imaging result.

According to this aspect of the invention, what position in the taken image the arrangement detecting image projected by the own projector is projected at can be measured in advance in each of the projectors.

(8) According to another aspect of the invention, a projector is provided. The projector is a projector included in one of projector groups each formed of N projectors, and the number N is an integer no smaller than 1 determined for each of the projector groups. The projector includes a projection section adapted to project an image on a projection surface, a control section, and an imaging section. The control section makes the projection section perform projection so that the N projectors belonging to the projector group project N arrangement detecting images different from each other at a timing different between the projector groups, and makes the imaging section perform imaging in a case in which the own projector is not projecting the arrangement detecting image, and detects an arrangement state of images projected by the projectors based on the imaging result and an imaging result by another projector.

According to this aspect of the invention, the arrangement state of the images projected by the plurality of projectors can be detected with smaller number of arrangement detecting images compared to the related art technology. Further, related to a larger number of projectors than in the related part technology, it is possible to detect the arrangement state of the images projected by the projectors.

(9) According to another aspect of the invention, a projection position detection method adapted to detect an arrangement state of images projected by a plurality of projectors regarding the plurality of projectors adapted to project the images arranged on a projection surface is provided. Each of the projectors is provided with an imaging section capable of imaging at least a part of a projection range of another of the projectors when the another of the projectors performs projection at a position adjacent to a projection range of an own projector. The plurality of projectors is classified into a plurality of projector groups, and the number N is an integer no smaller than 1 determined for each of the projector groups. The projection position detection method includes (i) making the N projectors belonging to the projector group project N arrangement detecting images different from each other at a timing different between the projector groups, (ii) making the projector which does not project the arrangement detecting image perform imaging by the imaging section, and (iii) detecting an arrangement state of images projected by the plurality of projectors based on the imaging result obtained in (ii).

According to this aspect of the invention, the arrangement state of the images projected by the plurality of projectors can be detected with smaller number of arrangement detecting images compared to the related art technology. Further, related to a larger number of projectors than in the related part technology, it is possible to detect the arrangement state of the images projected by the projectors.

The invention can be realized in a variety of forms such as a projector, or an image adjustment method besides the projection system.

### BRIEF DESCRIPTION OF THE DRAWINGS

The invention will be described with reference to the accompanying drawings, wherein like numbers reference like elements.

FIG. 1 is an explanatory diagram showing a projection system.

FIG. 2 is an explanatory diagram showing a positional relationship between a projector and a projection surface.

FIG. 3 is a flowchart of an arrangement state determination process according to a first embodiment of the invention.

FIG. 4 is an explanatory diagram showing the projection state of the projection surface in the step S130 shown in FIG. 3.

FIG. 5 is an explanatory diagram showing the projectors (projecting projectors) having performed projection and the detection state of an arrangement detecting image in an imaging section of each of the projectors.

FIG. 6 is a flowchart showing a process in the step S160 shown in FIG. 3.

FIG. 7 is an explanatory diagram showing an arrangement relationship of the images obtained in the process shown in FIG. 6.

FIG. 8 is an explanatory diagram showing the projectors (projecting projectors) having performed projection according to a second embodiment, and the detection state of an arrangement detecting image in an imaging section of each of the projectors.

FIG. 9 is a flowchart of an image adjustment process according to a third embodiment of the invention.

### DESCRIPTION OF EXEMPLARY EMBODIMENTS

### First Embodiment

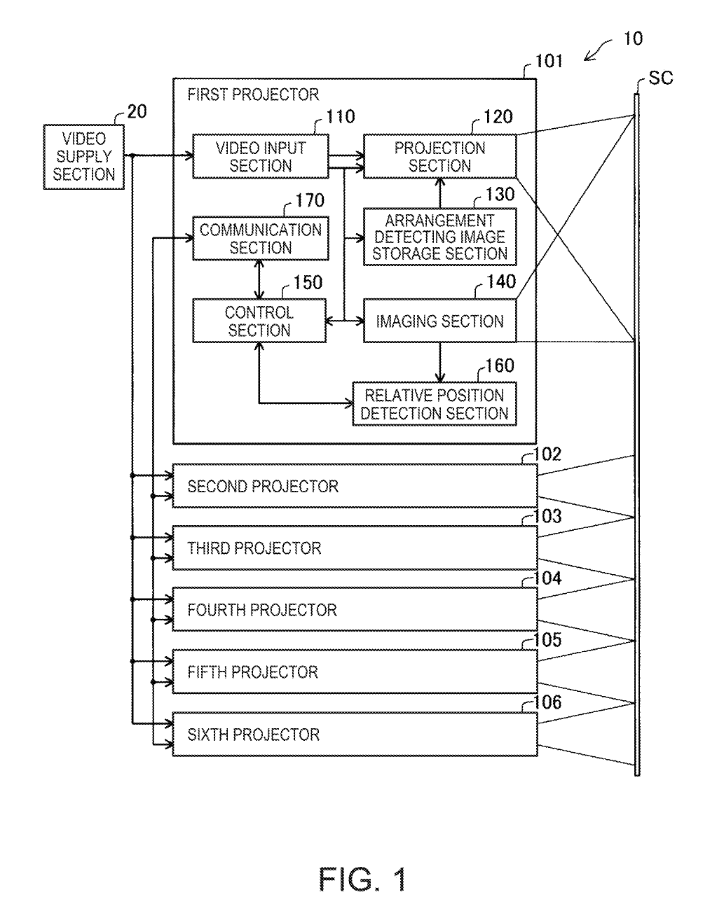

FIG. 1 is an explanatory diagram showing a projection system 10. The projection system 10 is provided with a video supply section 20, a plurality of projectors 101 through 106, and a projection surface SC. It is sufficient for the video supply section 20 to be a device such as a computer or a television capable of supplying a picture or an image to be projected by the projectors 101 through 106. As the projection surface SC, there can be used an interior wall, an exterior wall of a building, and so on besides the screen as long as there is provided a surface, on which the picture or the image projected by the projectors 101 through 106 can be projected.

The projectors 101 through 106 are capable of projecting the image obtained by dividing a large screen on the projection surface SC when receiving a supply of a large-screen picture or a large-screen image from the video supply section 20. Although in the first embodiment, there are provided the six projectors 101 through 106, the number of projectors included in the single projection system 10 can also be an arbitrary number. Since the configurations of the projectors 101 through 106 are the same as each other, the projector 101 will be described as an example. It should be noted that the projector 101 is referred to as a “first projector 101” in accordance with the trailing number of the reference numeral if need arises. It should be noted that the same applies to the projectors 102 through 106. The projectors 101 through 106 are divided into a plurality of projector groups each including N (N is an integer equal to or greater than 1) projectors. The value of N is set for each of the individual projector groups. It should be noted that in the first embodiment, N=1 is true in all of the projector groups, and each of the projector groups only includes one projector. Therefore, it is set that the six projectors 101 through 106 respectively belong to a first projector group through a sixth projector group in this order.

The projector 101 is provided with a video input section 110, a projection section 120, an arrangement detecting image storage section 130, an imaging section 140, a control section 150, a relative position detection section 160, and a communication section 170. The video input section 110 receives an input of a picture or an image from the video supply section 20. The projection section 120 projects the picture or the image on the projection surface SC. The arrangement detecting image storage section 130 stores the arrangement detecting image used when detecting the arrangement position (the projection position of the picture) of each of the projectors 101 through 106. As the arrangement detecting image, it is possible to use a solid image (also referred to as a “standard color image”) of a predetermined color, or a pattern image including a mark such as a dot or a grid. The standard color image can also be used for the adjustment of the color of the projector. As the predetermined color, for example, white, red, blue, or green is used. Further, the pattern image including the mark such as a dot or a grid can also be used for the correction of the position shift of the projection position between the projectors or a keystone correction. It should be noted that in the present specification, the description of the adjustment of the color of the projector, the position shift of the projection position between the projectors, and the keystone correction will be omitted.

It should be noted that one of the plurality of projectors 101 through 106 operates as a master projector, and the other projectors operate as slave projectors, and thus, it is possible for the plurality of projectors 101 through 106 to operate in a coordinated manner. On this occasion, the control section 150 of the master projector functions as a control device for controlling the overall operation of the plurality of projectors 101 through 106. In the following description, the term “control section 150” mainly means the control section 150 of the master projector. It should be noted that it is possible to arrange that there is disposed a control device for controlling the coordinated operation besides the control sections 150 of the projectors 101 through 106.

The imaging section 140 takes the arrangement detecting image projected on the projection surface SC by the projection section 120. The imaging section 140 is capable of imaging at least a part of the projection range of the projector adjacent to the own projector 101. Specifically, in the case in which the projector adjacent to the own projector 101 projects the arrangement detecting image, the imaging section 140 can detect at least a part of the arrangement detecting image projected by the adjacent projector. It should be noted that it is possible for the range to be imaged by the imaging section 140 to be slightly larger than the range in which the projection section 120 of the own projector 101 performs projection. The control section 150 has a function of controlling what part of the large-screen picture or the large-screen image supplied is the area, projection of which is handled by each of the projectors 101 through 106. The relative position detection section 160 detects the relative positional relationship between the projection position of each of the projectors and the arrangement detecting image using the taken images including the arrangement detecting images taken by the imaging sections 140 of the respective projectors. It should be noted that it is also possible to arrange that the control section 150 performs the function of the relative position detection section 160. The communication section 170 transmits and receives the detection data of the arrangement state with the communication sections 170 of the other projectors 102 through 106. The communication section 170 of each of the projectors 101 through 106 further transmits and receives a variety of signals necessary for the mutual coordinated operation with the communication sections 170 of the other projectors.

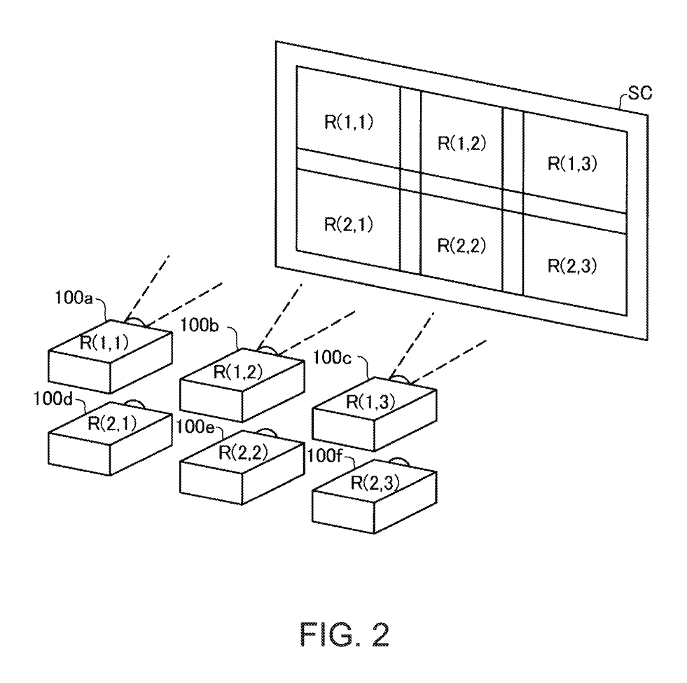

FIG. 2 is an explanatory diagram showing the positional relationship between projectors 100a through 100f corresponding to the projectors 101 through 106 shown in FIG. 1, and the projection surface SC. The projectors 100a through 100f perform projection on the projection surface SC in a 2×3 matrix. The top row is referred to as a “first row,” the second top row is referred to as a “second row,” the first column from the left is referred to as a “first column,” the second column from the left is referred to as a “second column,” and the third column from the left is referred to as a “third column.” The character i of the range R(i, j) on the projection surface SC represents the row number, and the character j represents the column number. In the first embodiment, the projector 100a performs projection in the range R(1, 1), the projector 100b performs projection in the range R(1, 2), the projector 100c performs projection in the range R(1, 3), the projector 100d performs projection in the range R(2, 1), the projector 100e performs projection in the range R(2, 2), and the projector 100f performs projection in the range R(2, 3). It should be noted that the projectors 101 through 106 shown in FIG. 1 each correspond one-on-one to either one of the projectors 100a through 100f shown in FIG. 2. It should be noted that each of the projectors 101 through 106 is in the state in which the projector does not know what position on the projection surface SC the own projection range is located. Therefore, as described hereinafter, the control section 150 detects which one of the ranges R(i, j) on the projection surface SC each of the projectors 101 through 106 performs projection in, namely the correspondence relationship (the arrangement state of the images to be projected) between the projectors 101 through 106 and the projectors 100a through 100f.

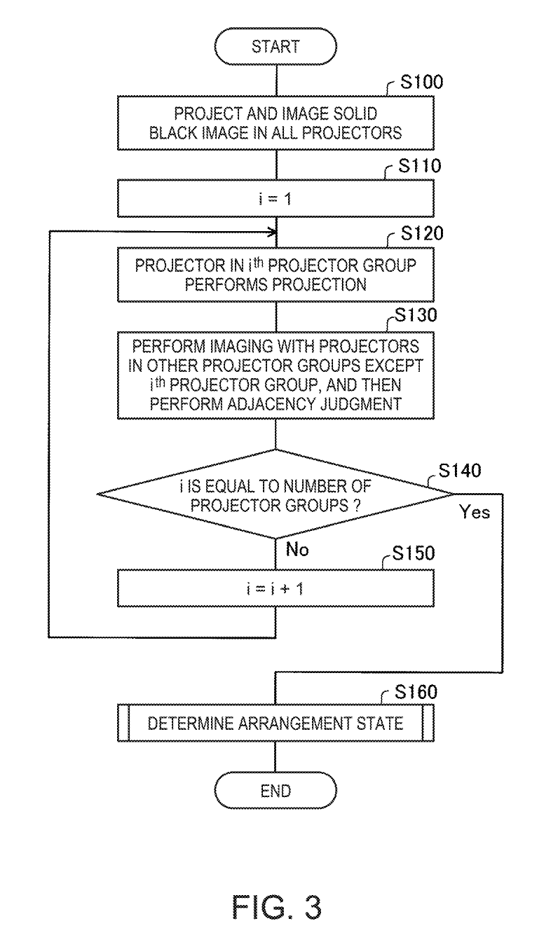

FIG. 3 is a flowchart of an arrangement state determination process in the first embodiment. In the step S100, the control section 150 makes all of the projectors 101 through 106 project a solid black image, and then makes the imaging section 140 perform imaging. This is for reliably determining that the adjacent projector projects the arrangement detecting image by performing the comparison with the solid black taken image when the adjacent projector projects the arrangement detecting image in a later process. It should be noted that the step S100 can be omitted.

In the step S110, the value of the parameter i for designating the projector group is initialized to 1. In the step S120, the control section 150 makes the projector in the i-th projector group project the arrangement detecting image. On this occasion, it is preferable for the projectors in the other projector groups to project the solid black image. It should be noted that in the case in which the i-th projector group includes two or more projectors (referred to as “N same-group projectors”), the N same-group projectors project the N arrangement detecting images different from each other. It should be noted that as described above, in the first embodiment, N=1 is true in all of the projector groups. In the step S130, the control section 150 makes the projectors in the other projector groups except the i-th projector group take the image of the projection surface SC. It should be noted that in the case in which the number N of the same-group projectors in the i-th projector group is equal to or greater than 2, it is preferable to also make the projector in the i-th projector group take the image of the projection surface SC. The relative position detection section 160 (or the control section 150) in each of the projector groups performs adjacency judgment on whether or not the arrangement detecting image exists in either of the positions (upper, lower, left, and right positions) adjacent to the projection range of the own projector. In the step S140, whether or not the value of i is equal to the number of the projector groups is determined. In the case in which the value of i is smaller than the number of the projector groups, the process makes the transition to the step S150, and then makes the transition to the step S120 after adding 1 to i. In the case in which the value of i is equal to the number of the projector groups, the process makes the transition to the step S160, and the control section 150 detects which one of the projectors 100a through 100f each of the projectors 101 through 106 corresponds to.

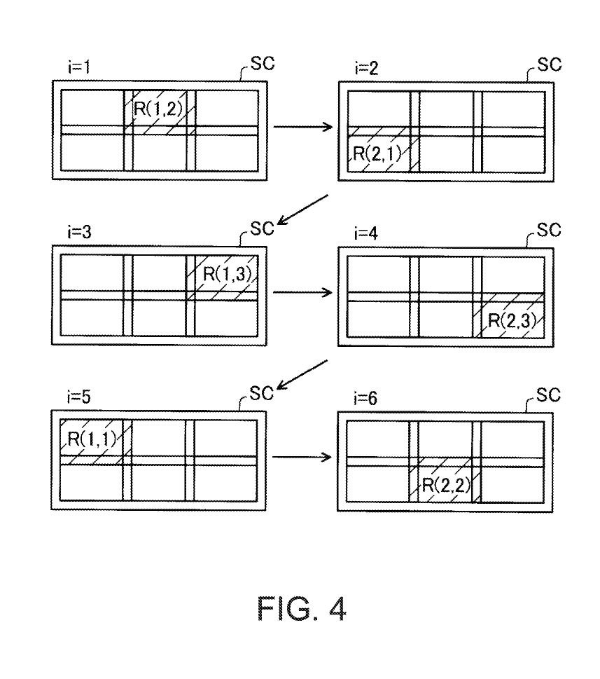

FIG. 4 is an explanatory diagram showing the projection state on the projection surface in the step S130 shown in FIG. 3.
In the case of i=1, the arrangement detecting image is projected at the position represented by the range R(1, 2).
In the case of i=2, the arrangement detecting image is projected at the position represented by the range R(2, 1).
In the case of i=3, the arrangement detecting image is projected at the position represented by the range R(1, 3).
In the case of i=4, the arrangement detecting image is projected at the position represented by the range R(2, 3).
In the case of i=5, the arrangement detecting image is projected at the position represented by the range R(1, 1).
In the case of i=6, the arrangement detecting image is projected at the position represented by the range R(2, 2).

It should be noted that the timings, at which the projector groups project the arrangement detecting image, are different between the projector groups, and every time the projector in each of the projectors projects the arrangement detecting image, the imaging sections 140 in the other projector groups (or the imaging sections 140 in all of the projector groups) perform imaging.

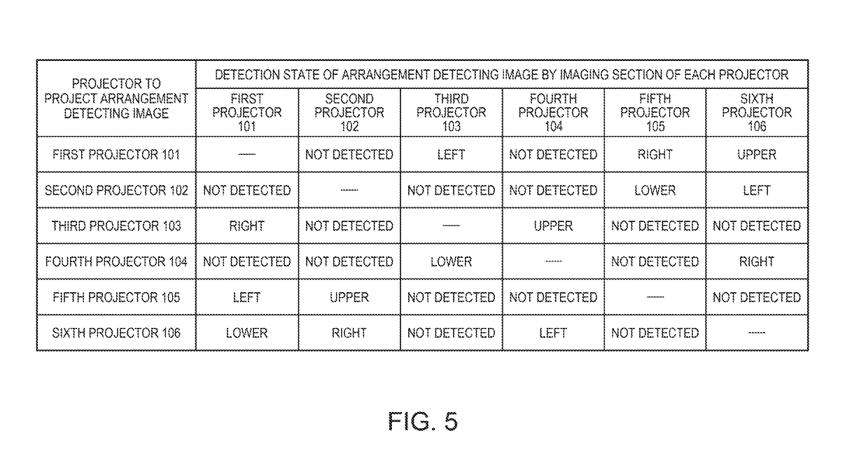

FIG. 5 is an explanatory diagram showing the projectors (projecting projectors) having projected the arrangement detecting image, and the detection state of the arrangement detecting image in the imaging section 140 of each of the projectors. For example, in the case in which the first projector 101 in the first projector group projects the arrangement detecting image, the second projector 102 and the fourth projector 104 belonging to the other projector groups do not detect the arrangement detecting image. Further, the third projector 103 belonging to the other projector group detects the arrangement detecting image on the left side of the own projection range, the fifth projector 105 detects the arrangement detecting image on the right side of the own projection range, and the sixth projector 106 detects the arrangement detecting image on the upper side of the own projection range. The control section 150 of each of the projectors records such a detection result. Regarding the projectors 102 through 106 in the other projector groups, such detection results (referred to as a “relative positional relationship detection result”) as shown in FIG. 5 can similarly be obtained.

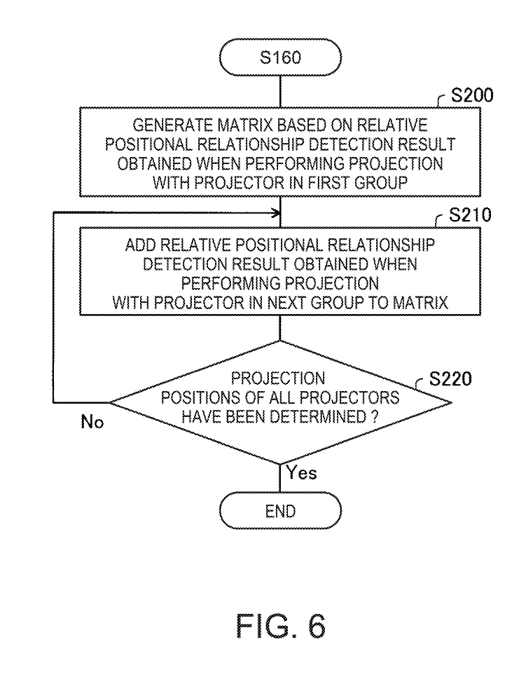

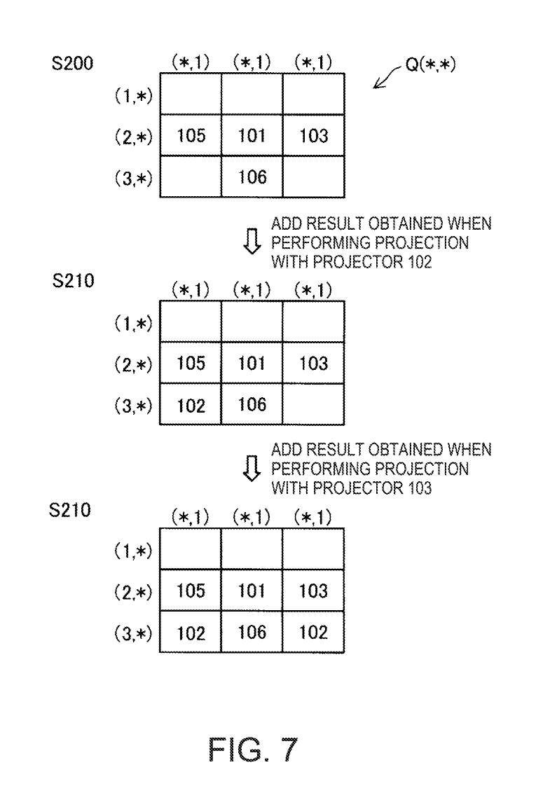

FIG. 6 is a flowchart showing a detailed procedure of a process in the step S160 shown in FIG. 3. FIG. 7 is a diagram showing the process in the step S160 shown in FIG. 3. In the step S200, the control section 150 generates a matrix Q(m, n) representing the relative positional relationship detection result using the relative positional relation detection in the case in which the projector 101 in the first projector group performs projection. The size m, n of the matrix Q is set to, for example, the value 2M twice as large as the total number M (M=6 in this example) of projectors 101 through 106. It should be noted that in FIG. 7, m=n=3 is set for the sake of convenience of illustration. The reference numeral 101 of the projector 101 is input to the center element Q (2, 2) of the matrix, and if there exists a projector adjacent to the projector 101 based on the result shown in FIG. 5, the reference numeral of the projector is input to corresponding one of the elements Q(1, 2), Q(2, 1), Q(2, 3), Q(3, 2) on the upper, lower, left, and right side of the center element Q(2, 2). In the first embodiment, since the projectors 103, 105, and 106 are adjacent to the projector 101, the reference numerals 103, 105, and 106 are input to the elements Q(2, 3), Q(2, 1), and Q(3, 2).

In the step S210, the relative positional relationship detection obtained in the case in which the projector 102 in the second projector group performs projection is added to the matrix Q. The reference numeral 102 of the projector 102 is input to the element Q(3, 1) based on the relative positions to the projectors 105, 106. It should be noted that in another embodiment, it is also possible to skip the steps S210, S220 in the case in which the reference numeral of the projector 102 in the present projector group does not exist in the matrix Q having been obtained at that moment in the step S210. In this case, the step S210 is executed with respect to the subsequent projector group.

In the step S220, the control section 150 determines whether or not the projection positions of all of the projectors have successfully been detected. If they have successfully been detected, there is no need to input the reference numeral of the projector to the matrix any further, and therefore, the process is terminated. If they have not been detected, the process returns to the step S210, and the step S210 is performed on the other projector groups which have been excluded from the processing object of the step S210.

When the process shown in FIG. 6 has been completed in such a manner as described above, such an arrangement state as shown in the lowermost part of FIG. 7 can be obtained. This arrangement state represents which of the projection positions of the projectors 100a through 100f shown in FIG. 2 the projection positions (the projection ranges) of the plurality of projectors 101 through 106 correspond to. It should be noted that in the routine shown in FIG. 6, there is no need to previously designate what matrix the image projected by the plurality of projectors 101 through 106 has (that the image is in the 3×2 matrix shown in FIG. 2), and it is possible to detect an arbitrary arrangement state.

As described hereinabove, according to the first embodiment, since it is sufficient to project and then take the arrangement detecting image as much as the number of the projectors included in one projector group, it is possible to detect the arrangement state of the images projected by the plurality of projectors with small number of arrangement detecting images.

Further, it is preferable to set the number of the projectors included in one projector group to 1 (N=1), from the viewpoint that it is sufficient to prepare one arrangement detecting image alone.

Although in the present embodiment, the relative position detection section 160 of the control section 150 is provided to each of the projectors 101 through 106, it is also possible to adopt a configuration in which the relative position detection section 160 is provided only to a single projector, for example, the first projector 101. Further, it is also possible to configure the relative position detection section 160 as a separate device from the projector.

Further, although in the present embodiment, the projector, which is not projecting the arrangement detecting image, is judging whether or not the arrangement detecting image exists at a position adjacent to the upper, lower, left, or right side of the own projection range, it is also possible to arrange to judge whether or not the arrangement detecting image exists at a position adjacent in a tilted direction.

### Second Embodiment

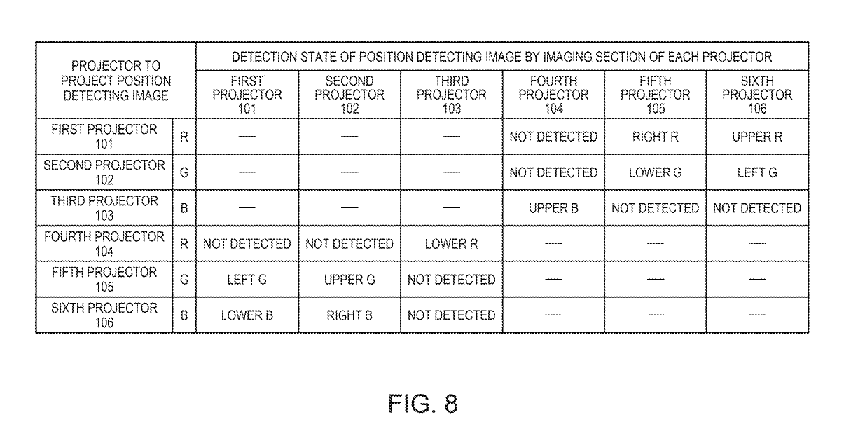

FIG. 8 is an explanatory diagram showing the projectors (projecting projectors) having performed projection according to a second embodiment, and the detection state of the arrangement detecting image in the imaging section 140 of each of the projectors. In the first embodiment described above, the number N of the projectors included in the projector group is set to N=1, the projectors 101 through 106 project the arrangement detecting image in sequence, and the other projectors not performing the projection perform imaging. However, in the second embodiment, the projectors 101 through 106 are divided into projector groups each including N (N=3) projectors, the N arrangement detecting images different from each other are projected for each projector group, and at the same time, the projectors not projecting the arrangement detecting image are made to perform imaging by the imaging section 140. It should be noted that the value of N is preferably equal to or smaller than 3. If the value of N is equal to or smaller than 3, the three primary colors (RGB) of light can be used as the arrangement detecting images. In the case of projecting the N arrangement detecting images different from each other, each of the projectors distinctly records presence or absence of the detection of the arrangement detecting image, the position of the arrangement detecting image, and the type (R, G, or B) of the arrangement detecting image. The control section 150 performs the steps S200 through S230 shown in FIG. 6, and on that occasion, the relative relationship between the projectors 101 through 106 can be detected based on the direction in which each of the projectors has detected the arrangement detecting image with respect to the own projection range, and the type of the arrangement detecting image having been detected by each of the projectors.

In FIG. 8, the three projectors 101 through 103 constitute the first projector group, and the projectors 101 through 103 project a red image, a green image, and a blue image as the arrangement detecting images different from each other. Further, the other three projectors 104 through 106 constitute the second projector group, and the projectors 104 through 106 project a red image, a green image, and a blue image as the arrangement detecting images different from each other. By similarly processing, in the same manner as in FIG. 6, the relative positional relationship detection result obtained in such a manner, it is possible to obtain the arrangement state of the images projected by all of the projectors 101 through 106.

### Third Embodiment

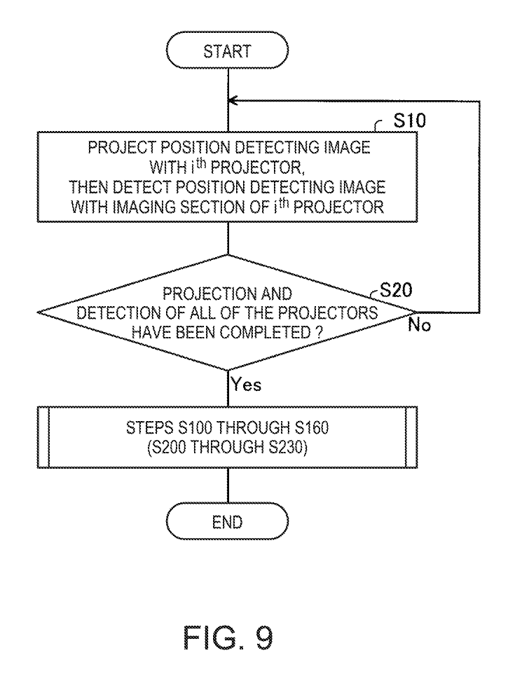

FIG. 9 is a flowchart of an image adjustment process in a third embodiment. The third embodiment is different in the point that the steps S10, S20 are performed before the step S100 of the flowchart of the first embodiment shown in FIG. 3. Therefore, the steps S10, S20 will be described here.

In the step S10, the control section 150 makes the i-th projector (i represents either one of 1 through 6) project an own position detecting image (e.g., a solid white image), and then makes the imaging section 140 of the i-th projector take the image of the projection surface. The relative position detection section 160 of the i-th projector detects what position in the own imaging range the own position detecting image has been projected at using the taken image. Here, the value i sequentially takes 1 through the largest number corresponding to the number of projectors (“6” in the third embodiment). In the step S20, the control section 150 determines whether or not the projection and the detection by all of the projectors have been completed. If they have been completed, the process makes the transition to the step S100 in FIG. 3, and if not, the process returns to the step S10.

In general, the position and the size of the picture, which has been projected by the own projector, and shows in the taken image of the imaging section 140, vary due to the projection distance, the zoom lens shift of the projection lens (not shown) of the projection section 120, and so on. Therefore, unless what position in the taken image of the imaging section 140 the picture projected by the own projector shows has been measured and recognized in advance, there is a possibility of taking the arrangement detecting image projected by another projector belonging to the same projector group for the arrangement detecting image projected by the own projector when performing the measurement. According to the third embodiment, since it is possible to measure and recognize, in advance, where the image projected by the own projector is projected in the taken image of the imaging section 140 in each of the projectors, there is no chance of taking the arrangement detecting image projected by another projector belonging to the same projector group for the measurement detecting image projected by the own projector in performing the measurement.

Although the embodiments of the invention is hereinabove described based on some specific examples, the embodiments of the invention described above are only for making it easy to understand the invention, but not for limiting the scope of the invention. It is obvious that the invention can be modified or improved without departing from the scope of the invention and the appended claims, and that the invention includes the equivalents thereof.

What is claimed is:

1. A projection system comprising:
a plurality of projectors adapted to project respective images arranged on a projection surface, and
a control device,
wherein each of the projectors is provided with an imaging section capable of imaging at least a part of a projection range of another of the projectors when the another of the projectors performs projection at a position adjacent to a projection range of an own projector,
the projectors are classified into a plurality of projector groups each formed of N projectors,
the number N is an integer no smaller than 1 determined for each of the projector groups, and
the control device makes the N projectors belonging to the projector group project N arrangement detecting images different from each other at a timing different between the projector groups, and makes the projector which does not project the arrangement detecting image perform imaging by the imaging section to detect an arrangement state of images projected by the plurality of projectors based on the imaging result.

2. The projection system according to claim 1, wherein
the number N is 1 in all of the projector groups.

3. The projection system according to claim 1, wherein
the number N is no smaller than 2 in at least one of the projector groups, and
in a case of making the N projectors belonging to the projector group in which the number N is no smaller than 2 project the N arrangement detecting images different from each other, the control device makes the projector which projects the arrangement detecting image perform imaging by the imaging section in addition to the projector which does not project the arrangement detecting image.

4. The projection system according to claim 1, wherein
each of the projectors is provided with a relative position detection section adapted to detect a relative positional relationship of the arrangement detecting image relative to an own projection position based on the imaging result of the imaging section, and
the control device detects the arrangement state based on the relative positional relationship detected by the relative position detection section.

5. The projection system according to claim 4, wherein
the control device makes the projector project an own position detecting image at a timing different between the projectors, and makes the imaging section perform imaging before projecting the arrangement detecting image, and
the relative position detection section detects the own projection position based on the imaging result.

6. The projection system according to claim 1, wherein
the control device is a control section provided to one of the projectors.

7. The projection system according to claim 1, wherein
the control device makes the projectors sequentially project own position detecting images at timings different between the projectors, then makes the imaging section perform imaging before projecting the arrangement detecting image, and then recognizes a projection position of the projector in an imaging range of the imaging section of each of the projectors based on the imaging result.

8. A projector included in one of projector groups each formed of N projectors, the number N being an integer no smaller than 1 determined for each of the projector groups, the projector comprising:
a projection section adapted to project an image on a projection surface;
a control section; and
an imaging section,
wherein the control section
makes the projection section perform projection so that the N projectors belonging to the projector group project N arrangement detecting images different from each other at a timing different between the projector groups, and
makes the imaging section perform imaging in a case in which the own projector is not projecting the arrangement detecting image, and detects an arrangement state of images projected by the projectors based on the imaging result and an imaging result by another projector.

9. A projection position detection method adapted to detect an arrangement state of images projected by a plurality of projectors regarding the plurality of projectors adapted to project the images arranged on a projection surface, each of the projectors being provided with an imaging section capable of imaging at least a part of a projection range of another of the projectors when the another of the projectors performs projection at a position adjacent to a projection range of an own projector, the projectors being classified into a plurality of projector groups each formed of N projectors, and the number N being an integer no smaller than 1 determined for each of the projector groups, the method comprising:
(i) making the N projectors belonging to the projector group project N arrangement detecting images different from each other at a timing different between the projector groups;
(ii) making the projector which does not project the arrangement detecting image perform imaging by the imaging section; and
(iii) detecting an arrangement state of images projected by the plurality of projectors based on the imaging result obtained in (ii).
